(19) United States
(12) Patent Application Publication
(10) Pub. No.: US 2011/0285573 A1
(43) Pub. Date: Nov. 24, 2011

(54) INTEGRATED RADAR SYSTEM AND VEHICLE CONTROL SYSTEM

(75) Inventor: Seong Hee JEONG, Seoul (KR)

(73) Assignee: MANDO CORPORATION

(21) Appl. No.: 13/109,345

(22) Filed: May 17, 2011

(30) Foreign Application Priority Data
May 18, 2010 (KR) 10-2010-0046491

(51) Int. Cl. G01S 13/00; G01S 13/08; G01S 13/42

(52) U.S. Cl. 342/70; 342/175; 342/146; 342/118

(57) ABSTRACT

An integrated radar system and a vehicle control system are provided. More particularly, an antenna structure that can sense multiple distances using multiple beams, an integrated radar system using the same, and a vehicle control system that performs vehicle control through multiple distance sensing of a target are provided.

### CROSS-REFERENCE TO RELATED APPLICATION

This application claims priority from and the benefit under 35 U.S.C. §19(a) of Korean Patent Application No. 10-2010-0046491, filed on May 18, 2010, which is hereby incorporated by reference for all purposes as if fully set forth herein.

### BACKGROUND OF THE INVENTION

1. Field of the Invention

The present invention relates to an integrated radar system and a vehicle control system, and more particularly to an antenna structure that can sense multiple distances using multiple beams, an integrated radar system using the same, and a vehicle control system that performs vehicle control through multiple distance sensing of a target.

2. Description of the Prior Art

With the trend of vehicle intelligence, vehicles in the related art are mounted with various vehicle control systems, such as an ACC (Adaptive Cruise Control) system for in-path sensing, an LCA (Land-Change Assist) system that performs a rear side lane sensing function, a stop & go system that performs front sensing and collision prevention functions, a parking assist system that performs parking control, an LCA (Lane-Change Assist)/BSD (Blind-Spot Detection)/RPC (Rear Pre Crash) system that performs collision warning and collision prevention functions through sensing of a side rear side and a vehicle that cuts in from a side lane, and the like.

However, such various vehicle control systems have different sensing ranges with respect to required targets, and thus have different transmission distances of used signals.

As described above, for the vehicle control systems that require different sensing ranges, it is required to separately mount radar systems (which may be called radars, radar sensors, or radar apparatuses) that can sense targets by sensing ranges on a vehicle, and this causes the number of radar systems that should be mounted on the vehicle to increase and causes a space for mounting the radar systems therein also to increase.

### SUMMARY OF THE INVENTION

Accordingly, the present invention has been made to solve the above-mentioned problems occurring in the related art, and an object of the present invention is to provide an integrated radar system that can sense multiple distances using multiple beams.

Another object of the present invention is to provide an antennal structure that can sense multiple distances using multiple beams.

Still another object of the present invention is to provide an integrated radar system that can sense targets in various sensing ranges, so that it is not required to mount many radar systems for various sensing ranges on a vehicle, and thus cost savings and mount space reduction become possible to improve the vehicle mount/applicability.

Yet still another object of the present invention is to provide a vehicle control system that senses targets in various sensing ranges and performs vehicle control through the sensed targets.

In accordance with one aspect of the present invention, there is provided an integrated radar system, which includes a transmission antenna unit including a plurality of transmission antenna groups having different sensing ranges; and a reception antenna group receiving reception signals through multiple channels.

In accordance with another aspect of the present invention, there is provided a vehicle control system, which includes a signal transmission unit transmitting a transmission signal through a specified transmission antenna group having a specified sensing range among a plurality of transmission antenna groups having different sensing ranges; a signal reception unit receiving a reception signal, for which the transmission signal is reflected by a target that is located in the specified sensing range, through a reception antenna; a target sensing unit sensing the target based on the reception signal; and a control unit performing vehicle control using the result of the target sensing.

As described above, according to an embodiment of the present invention, an integrated radar system having an antenna structure that can sense multiple distances using multiple beams is provided.

Also, according to an embodiment of the present invention, an antenna structure which can sense multiple distances using multiple beams while realizing a high angular resolution is provided.

Also, according to an embodiment of the present invention, an integrated radar system that can sense targets in various sensing ranges is provided, so that it is not required to mount many radar systems for various sensing ranges on a vehicle, and thus cost savings and mount space reduction become possible to improve the vehicle mount/applicability.

Also, according to an embodiment of the present invention, a vehicle control system that senses targets in various sensing ranges and performs vehicle control through the sensed targets is provided.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram exemplarily illustrating the kinds of sensing ranges which are sensible by an integrated radar system and the corresponding multiple beams according to an embodiment of the present invention;

FIG. 2 is a block diagram illustrating the configuration of an integrated radar system according to an embodiment of the present invention;

FIG. 3 is a diagram exemplarily illustrating a short-distance sensing range, an intermediate-distance sensing range, and a long-distance sensing range of an integrated radar system mounted on a vehicle for vehicle controls requiring a short-distance target sensing, an intermediate-distance target sensing, and a long-distance target sensing, respectively;

FIG. 4 is a diagram exemplarily illustrating a short-distance sensing range and an intermediate-distance sensing range of an integrated radar system mounted on a vehicle for vehicle controls requiring a short-distance target sensing and an intermediate-distance target sensing, respectively;

FIG. 5 is a diagram exemplarily illustrating one transmission antenna group in order to explain the characteristics of an antenna structure of an integrated radar system according to an embodiment of the present invention;

FIG. 6 is an exemplary diagram illustrating beams having different sensing ranges and antenna gains for a short-distance sensing range, an intermediate-distance sensing range, and a long-distance sensing range, in accordance with an antenna structure including a short-distance transmission antenna group, an intermediate-distance transmission antenna group, and a long-distance transmission antenna group, which have different sensing ranges, in an integrated radar system according to an embodiment of the present invention; and

FIG. 7 is a block diagram illustrating the configuration of a vehicle control system according to an embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

An integrated radar system according to an embodiment of the present invention is a system that can sense multiple beams and multiple distances in order to sense targets located in various sensing ranges. Such an integrated radar system may be a radar apparatus, a radar sensor, a sensor, or the like.

Here, the term “sensing range” may mean the range in which an object (a target) that is separated by a specified distance in a specified direction (for example, forward, to the side, rearward, and the like) can be sensed, and may also mean the range in which a transmission signal for sensing can reach. This sensing range may be defined by the maximum sensing distance and the maximum sensing angle, in which the target can be sensed. Different sensing ranges mean that one or more of the maximum sensing distance and the maximum sensing angle are different from each other.

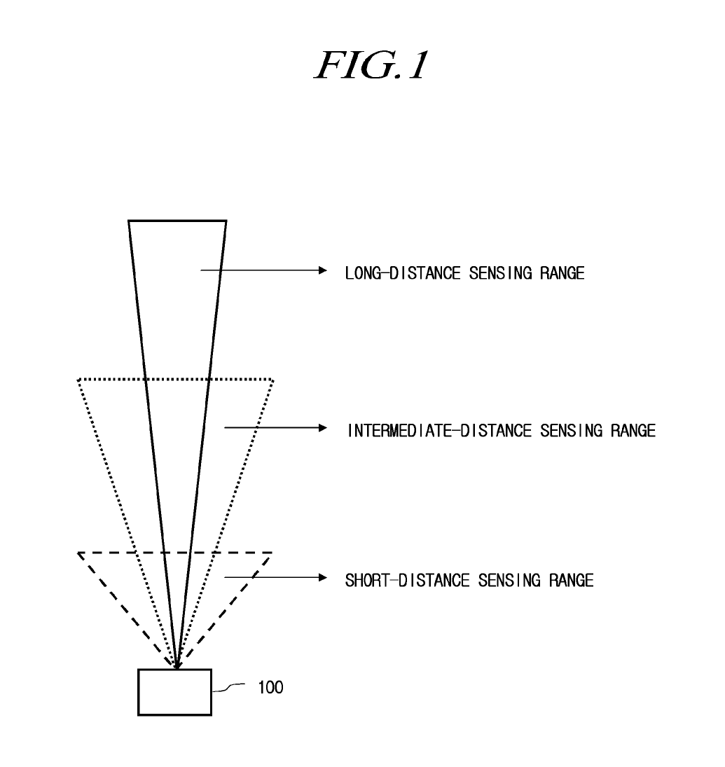

The kinds of sensing ranges which are sensible by an integrated radar system and the corresponding multiple beams according to an embodiment of the present invention are exemplarily illustrated in FIG. 1.

Referring to FIG. 1, an integrated radar system 100 according to an embodiment of the present invention can form two or more different sensing ranges and different beams according to the respective sensing ranges. However, for convenience in explanation, FIG. 1 exemplarily illustrates that the integrated radar system 100 according to an embodiment of the present invention supports three different sensing ranges including a short-distance sensing range, an intermediate-distance sensing range, and a long-distance sensing range, and forms different beams for the three different sensing ranges, respectively. The following description will follow this exemplification.

Hereinafter, the integrated radar system 100 according to an embodiment of the present invention will be described with reference to accompanying drawings.

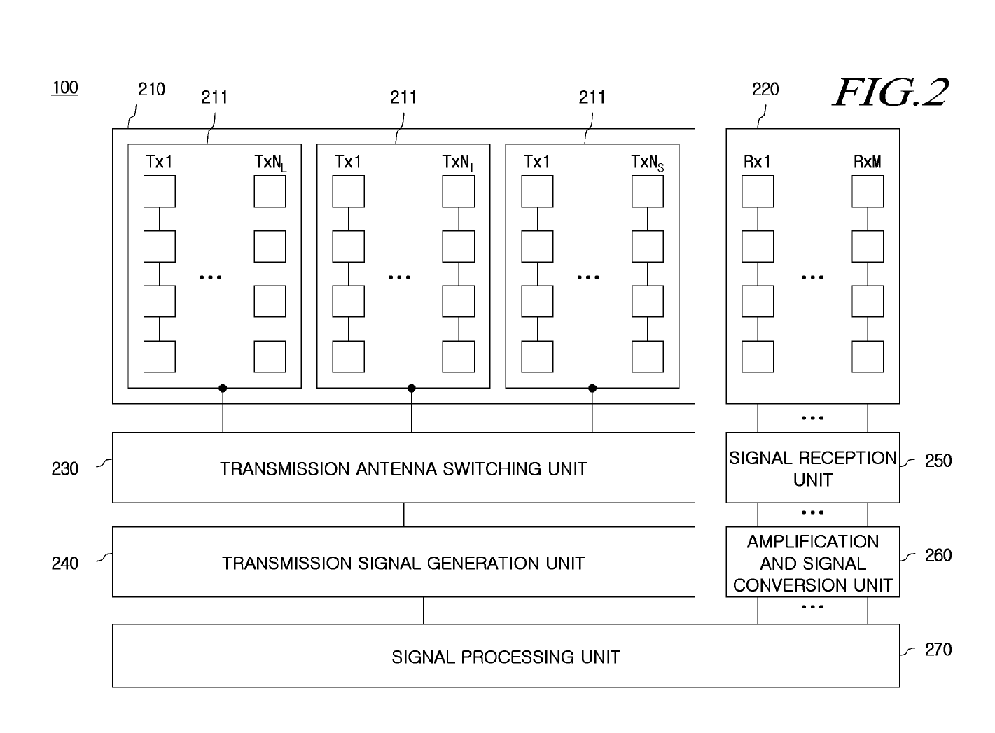

FIG. 2 is a block diagram illustrating the configuration of the integrated radar system 100 according to an embodiment of the present invention.

Referring to FIG. 2, the integrated radar system 100 according to an embodiment of the present invention has a particular antenna structure that can sense multiple beams and multiple distances. For this, the integrated radar system 100 includes a transmission antenna unit 210 including a plurality of transmission antenna groups having different sensing ranges, and a reception antenna group 220 including reception antennas for receiving receptions signals through multiple channels.

Referring to FIG. 2, each of the plurality of transmission antenna groups included in the transmission antenna unit 210 has an antenna structure in which one or more transmission antennas are arranged according to the number of antennas and an antenna interval, which are for differently setting the maximum sensing distance and the maximum sensing angle so that the transmission antennas have different sensing ranges.

Referring to FIG. 2, the plurality of transmission antenna groups, for example, may include two or more of a long-distance transmission antenna group 211 including N long-distance transmission antennas Tx1 to TxN_{long-distance}(TxN_{L}), an intermediate-distance transmission antenna group 212 including N intermediate-distance transmission antennas Tx1 to TxN_{intermediate-distance} (TxN_{I}), and a short-distance transmission antenna group 213 including N short-distance transmission antennas Tx1 to TxN_{short-distance}(TxN_{S}).

However, in FIG. 2, for convenience in explanation, it is exemplified that the plurality of transmission antenna groups includes three transmission antenna groups, that is, the long-distance transmission antenna group 211, the intermediate-distance transmission antenna group 212, and the short-distance transmission antenna group 213. Also, the numbers of antennas N_{long-distance}, N_{intermediate-distance}, and N_{short-distance} in the respective transmission antenna groups may be values that are equal to or larger than “1”.

The plurality of transmission antenna groups 211, 212, and 213 has antenna structures having different sensing ranges. Here, the different sensing ranges mean that one or more of the maximum sensing distance and the maximum sensing angle for sensing a target are different from each other.

The above-described maximum sensing range and maximum sensing angle may differ according to the antenna structures of the respective transmission antenna groups. The maximum sensing distance of the corresponding transmission antenna group may be in proportion to the number of antennas included in the corresponding transmission antenna group, and the maximum sensing angle of the corresponding transmission antenna group may be in reverse proportion to a value that is obtained by multiplying the number of the transmission antennas included in the corresponding transmission antenna group by an antenna interval between the transmission antennas.

The long-distance transmission antenna group 211 has a long-distance sensing range in which the maximum sensing distance and the maximum sensing angle are set as a long-distance value and a narrow angle, and N long-distance transmission antennas N_{long-distance} are arranged at an antenna interval of d_{long-distance} based on the number of antennas N_{long-distance} and the antenna interval d_{long-distance}. The intermediate-distance transmission antenna group 212 has an intermediate-distance sensing range in which the maximum sensing distance and the maximum sensing angle are set as an intermediate-distance value and an intermediate angle, and N intermediate-distance transmission antennas N_{intermediate-distance} are arranged at an antenna interval of d_{intermediate-distance} based on the number of antennas N_{intermediate-distance} and the antenna interval d_{intermediate-distance}. The short-distance transmission antenna group 213 has a short-distance sensing range in which the maximum sensing distance and the maximum sensing angle are set as a short-distance value and a wide angle, and N short-distance transmission antennas N_{short-distance} are arranged at an antenna interval of d_{short-distance} based on the number of antennas N_{short-distance} and the antenna interval d_{short-distance}. In other words, if there are desired sensing ranges (the maximum sensing distances and the maximum sensing angles), the respective transmission antenna groups 211, 212, and 213 vary the corresponding sensing ranges by adjusting the numbers of antennas and the antenna intervals.

Also, the plurality of transmission antenna groups 211, 212, and 213 has antenna gains that are in proportion to the corresponding numbers of antennas N N_{long-distance}, N_{intermediate-distance}, and N_{short-distance} and the corresponding maximum sensing distances.

On the other hand, the integrated radar system 100 according to an embodiment of the present invention selects which transmission antenna group is to be used among the plurality of transmission antenna groups 211, 212, and 213 in order to transmit the transmission signal for sensing the target that is located in the specified sensing range.

In order to select the transmission antenna group having the specified sensing range for sensing the target therein, the integrated radar system 100 according to an embodiment of the present invention, as illustrated in FIG. 2, may further include a transmission antenna switching unit 230 that selects and switches the specified transmission antenna group having the specified sensing range among the plurality of transmission antenna groups 211, 212, and 213 to transmit the transmission signal to the specified sensing range.

Two or more of the vehicle control that requires the long-distance sensing range, the vehicle control that requires the intermediate-distance sensing range, and the vehicle control that requires the short-distance sensing range may be required at the same time, or only one of them may be required.

In order to simultaneously transmit the transmission signals to the plurality of specified sensing ranges (for example, two or more of the long-distance sensing range, the intermediate-distance sensing range, and the short-distance sensing range) among the plurality of sensing ranges (for example, the long-distance sensing range, the intermediate-distance sensing range, and the short-distance sensing range) in the case where two or more of the vehicle control that requires the long-distance sensing range, the vehicle control that requires the intermediate-distance sensing range, and the vehicle control that requires the short-distance sensing range are required at the same time, the above-described transmission antenna switching unit 230 may perform switching of the specified transmission antenna groups (two or more of the plurality of transmission antenna groups 211, 212, and 213) having the specified sensing ranges among the plurality of transmission antenna groups 211, 212, and 213 one by one in a time division method.

Each of the plurality of transmission antenna groups 211, 212, and 213 included in the transmission antenna unit 210 includes one or more array antenna type transmission antennas.

For example, as illustrated in FIG. 1, the long-distance transmission antenna group 211 includes N transmission antennas Tx1 to TxN_{long-distance}, which correspond to the number of antennas having the long-distance sensing range (maximum sensing distance=long-distance value, maximum sensing angle=narrow angle value). The intermediate-distance transmission antenna group 212 includes N transmission antennas Tx1 to TxN_{intermediate-distance}, which correspond to the number of antennas having the intermediate-distance sensing range (maximum sensing distance=intermediate-distance value, maximum sensing angle=intermediate angle value). The short-distance transmission antenna group 213 includes N transmission antennas Tx1 to TxN_{short-distancer}, which correspond to the number of antennas having the short-distance sensing range (maximum sensing distance=short−distance value, maximum sensing angle=wide angle value).

The reception antenna unit 220, as illustrated in FIG. 1, includes a plurality of array antenna type reception antennas Rx1 to RxM, and receives reception signals through multiple channels.

As described above, since the reception antenna unit 220 includes the plurality of reception antennas Rx1 to RxM, the angle resolution, which is an index that can recognize the surrounding circumstances of a vehicle more accurately, can be heightened.

On the other hand, the integrated radar system 100 according to an embodiment of the present invention may further include a transmission signal generation unit 240 generating transmission signals which are transmitted through a specified transmission antenna group according to the switching of the transmission antenna switching unit 230, a signal reception unit 250 receiving reception signals in multiple channels through the plurality of reception antennas Rx1 to RxM of the reception antenna unit 220, and an amplification and signal conversion unit 260 amplifying and converting the reception signals into digital signals.

On the other hand, the integrated radar system 100 according to an embodiment of the present invention may further include a control unit which controls the transmission antenna switching unit 230 to perform switching of the plurality of transmission antenna groups 210, 220 and 230, and which performs vehicle control through the target sensing by respective sensing ranges based on the reception signals. The control unit may be an ECU (Electronic Control Unit) of the vehicle.

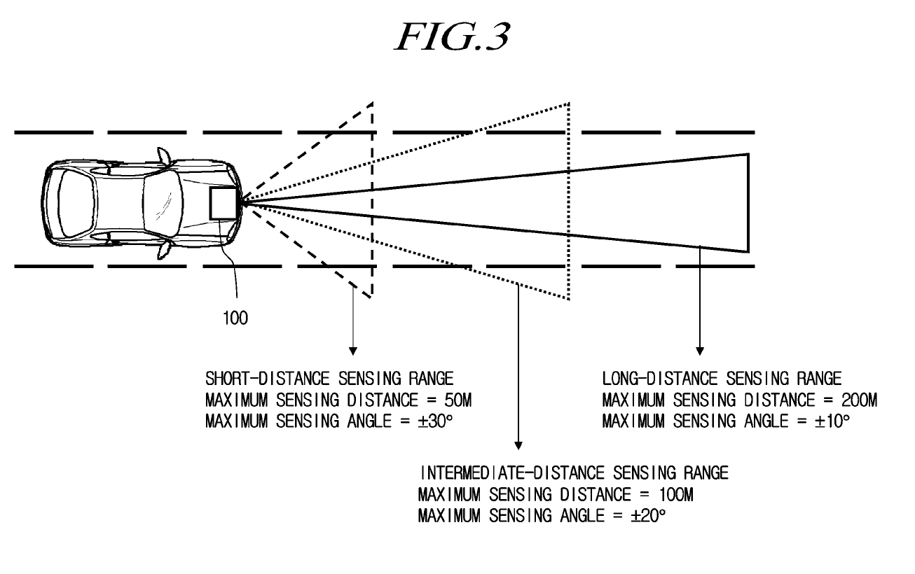

As described above, the integrated radar system 100 according to an embodiment of the present invention has been described. Hereinafter, a vehicle control application example of the integrated radar system 100 having the characteristics of a large number of sensing ranges, the antenna structure characteristics of the integrated radar system 100, and the corresponding multiple beams will be exemplarily described with reference to FIGS. 3 to 6.

FIG. 3 is a diagram exemplarily illustrating a short-distance sensing range, an intermediate-distance sensing range, and a long-distance sensing range of an integrated radar system 100 mounted on a vehicle for vehicle controls requiring a short-distance target sensing, an intermediate-distance target sensing, and a long-distance target sensing, respectively.

In an example of FIG. 3, it is assumed that the short-distance sensing range includes the maximum sensing distance of 50 m (short-distance value) and the maximum sensing angle of ±30° (wide angle value), the intermediate-distance sensing range includes the maximum sensing distance of 100 m (intermediate-distance value) and the maximum sensing angle of ±20° (intermediate angle value), and the long-distance sensing range includes the maximum sensing distance of 200 m (long-distance value) and the maximum sensing angle of ±10° (narrow angle value).

In order to perform the vehicle control that requires the target sensing with respect to the three kinds of sensing ranges as described above, the integrated radar system 100 should perform the target sensing function with respect to all three kinds of sensing ranges. A predetermined number of integrated radar systems 100 (in FIG. 3, one integrated radar system) may be mounted in predetermined positions of a vehicle (in FIG. 3, front portions of the vehicle) to match the target sensing function and the vehicle control function.

As illustrated in FIG. 3, a vehicle control system that requires three kinds of sensing ranges will be exemplified as follows.

Vehicle control related systems that require short-distance target sensing including the maximum sensing distance of about 50 m may include a stop & go system, an LCA (Lane-Change Assist) system, a BSD (Blind-Spot Detection) system, an RPC (Rear Pre Crash) system, an automatic parking system, and the like. The vehicle control related systems that require intermediate-distance target sensing including the maximum sensing distance of about 100 m may include an LCA system, an LKS (Lane Keeping System), and the like. Also, vehicle control related systems that require long-distance target sensing including the maximum sensing distance of about 200 m may include an ACC (Adaptive Cruise Control) system, an LKS system, and the like.

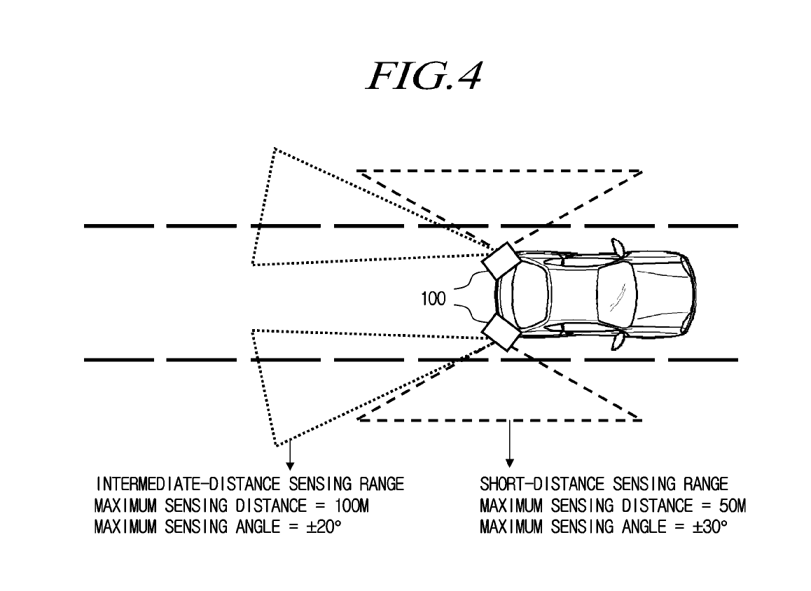

FIG. 4 is a diagram exemplarily illustrating a short-distance sensing range and an intermediate-distance sensing range of an integrated radar system mounted on a vehicle for vehicle controls requiring a short-distance target sensing and an intermediate-distance target sensing, respectively.

In an example of FIG. 4, it is assumed that the short-distance sensing range includes the maximum sensing distance of 50 m (short-distance value) and the maximum sensing angle of ±30° (wide angle value), and the intermediate-distance sensing range includes the maximum sensing distance of 100 m (intermediate-distance value) and the maximum sensing angle of ±20° (intermediate angle value).

In order to perform the vehicle control that requires the target sensing with respect to the two kinds of sensing ranges as described above, the integrated radar system 100 should perform the target sensing function with respect to both kinds of sensing ranges. A predetermined number of integrated radar systems 100 (in FIG. 4, two integrated radar systems) may be mounted in predetermined positions of a vehicle (in FIG. 4, rear corner portions of the vehicle) to match the target sensing function and the vehicle control function.

As illustrated in FIG. 4, a vehicle control system that requires two kinds of sensing ranges will be exemplified as follows.

Vehicle control related systems that require short-distance target sensing including the maximum sensing distance of about 50 m may include a stop & go system, an LCA (Lane-Change Assist) system, a BSD (Blind-Spot Detection) system, an RPC (Rear Pre Crash) system, an automatic parking system, and the like. The vehicle control related systems that require intermediate-distance target sensing including the maximum sensing distance of about 100 m may include an LCA system, an LKS (Lane Keeping System), and the like.

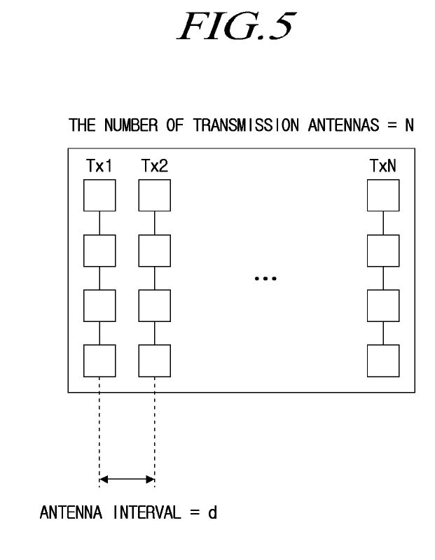

FIG. 5 is a diagram exemplarily illustrating one transmission antenna group in order to explain the characteristics of an antenna structure of a plurality of transmission antenna groups 211, 212, and 213 included in the transmission antenna unit 210 of the integrated radar system 100 according to an embodiment of the present invention.

The antenna structure of the transmission antenna group as illustrated in FIG. 5 will be described.

It is assumed that each of the respective transmission antennas included in the transmission antenna group as illustrated in FIG. 5 has an antenna gain of T(dBi) and a sensing angle of θ(degrees)

Also, the transmission antenna group as illustrated in FIG. 5 includes N transmission antennas Tx1 to TxN, and the respective transmission antennas are separated from each other at an interval of d(λ). That is, the number of antennas of the transmission antenna group as illustrated in FIG. 5 is N, and the antenna interval is d.

Also, it is assumed that the N transmission antennas Tx1 to T×N included in the transmission antenna group are of an array antenna type.

With the above-described antenna structure, the performance and the characteristics of the entire transmission antenna group are determined as follows.

The antenna gain G of the entire transmission antenna group is determined by the number of antennas N and an antenna gain of one transmission antenna, and may be expressed as in Equation (1) below.

G=T+10 log N(dBi) (1)

Also, the maximum sensing distance Rₘₐₓ of the transmission antenna group may be determined by the entire antenna gain G that is determined by the number of antennas and the like, and may be expressed as in Equation (2) below.

$${R}_{m ax} = {( \frac{{P}_{t} {G}^{2} {λ}^{2} σ}{{( 4 π )}^{3} {S}_{m i n}} )}^{1 / 4} \qquad ( 2 )$$

Since according to Equation (1), the antenna gain G is in proportion to the number of antennas N (specifically, in proportion to Log N), and according to Equation (2), the maximum sensing distance Rₘₐₓ is in proportion to the antenna gain G (specifically, in proportion to G^{1/2}), it is considered that the maximum sensing distance Rₘₐₓ is in proportion to the number of antennas N. Accordingly, the number of antennas N may be adjusted in order to adjust the maximum sensing distance Rₘₐₓ.

Also, according to the number of antennas N of the transmission antenna group and the antenna interval d, the maximum sensing angle may be changed. The maximum sensing angle θₘₐₓ is in reverse proportion to the number of antennas N and the antenna interval d, and its relationship equation may be expressed as in Equation (3) below.

$${θ}_{m ax} ∝ \frac{1}{N \times d} \qquad ( 3 )$$

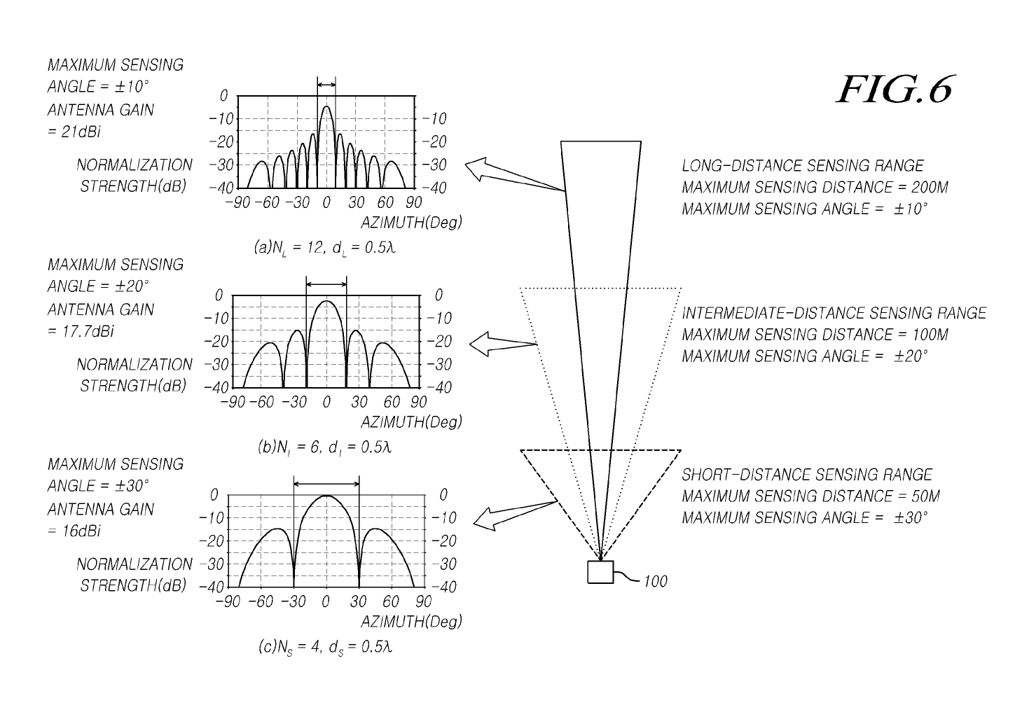

FIG. 6 is an exemplary diagram illustrating beams having different sensing ranges and antenna gains for a short-distance sensing range, an intermediate-distance sensing range, and a long-distance sensing range, in accordance with an antenna structure (see FIGS. 1, 2, and 3) including the short-distance transmission antenna group 213, the intermediate-distance transmission antenna group 212, and the long-distance transmission antenna group 211, which have different sensing ranges, in the integrated radar system 100 according to an embodiment of the present invention.

It is assumed that each transmission antenna group has an antenna structure as follows.

In the antenna structure of the long-distance transmission antenna group 211, the number of antennas N is 12, and the antenna interval d is 0.5λ. In the antenna structure of the intermediate-distance transmission antenna group 212, the number of antennas N is 6, and the antenna interval d is 0.5λ. In the antenna structure of the short-distance transmission antenna group 213, the number of antennas N is 4, and the antenna interval d is 0.5λ.

According to the antenna structure of the long-distance transmission antenna group 211 as described above, the beam waveforms in the long-distance sensing range of the integrated radar system 100 are as shown as (a) in FIG. 6. According to (a) in FIG. 6, the maximum sensing angle θₘₐₓ is ±10° (narrow angle value), and the antenna gain G is 21dBi. By substituting the antenna gain G of 21dBi in Equation (2), the maximum sensing distance Rₘₐₓ is calculated as 200 m.

According to the antenna structure of the intermediate-distance transmission antenna group 212 as described above, the beam waveforms in the intermediate-distance sensing range of the integrated radar system 100 are as shown as (b) in FIG. 6. According to (b) in FIG. 6, the maximum sensing angle θₘₐₓ is ±20° (intermediate angle value), and the antenna gain G is 17.7 dBi. By substituting the antenna gain G of 17.7 dBi in Equation (2), the maximum sensing distance Rₘₐₓ is calculated as 100 m.

According to the antenna structure of the short-distance transmission antenna group 213 as described above, the beam waveforms in the short-distance sensing range of the integrated radar system 100 are as shown as (c) in FIG. 6. According to (c) in FIG. 6, the maximum sensing angle θₘₐₓ is ±30° (wide angle value), and the antenna gain G is 16dBi. By substituting the antenna gain G of 16dBi in Equation (2), the maximum sensing distance Rₘₐₓ is calculated as 50 m.

As described above, the integrated radar system 100, the antenna structure of the integrated radar system 100, and the corresponding sensing range related characteristic according to an embodiment of the present invention have been described. Hereinafter, a vehicle control system that provides target sensing functions by diverse sensing ranges and performs the vehicle control using the provided target sensing functions will be described.

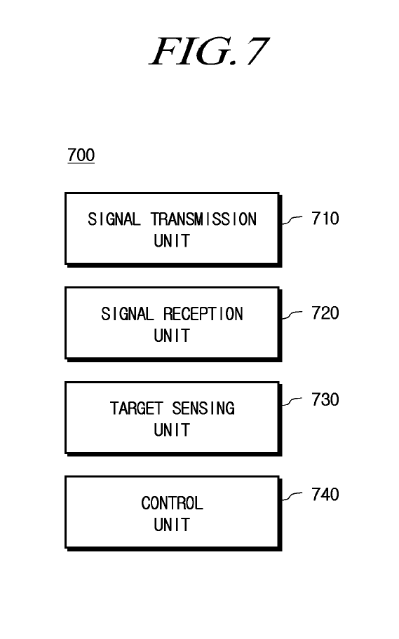

FIG. 7 is a block diagram illustrating the configuration of a vehicle control system 700 according to an embodiment of the present invention.

Referring to FIG. 7, the vehicle control system 700 according to an embodiment of the present invention includes a signal transmission unit 710 transmitting a transmission signal through a specified transmission antenna group having a specified sensing range among a plurality of transmission antenna groups having different sensing ranges; a signal reception unit 720 receiving a reception signal, for which the transmission signal is reflected by a target that is located in the specified sensing range, through a reception antenna; a target sensing unit 730 sensing the target based on the reception signal; and a control unit 740 performing vehicle control using the result of the target sensing.

The above-described transmission antenna groups may include two or more of the short-distance transmission antenna group having the short-distance sensing range in which the maximum sensing distance is set to a short-distance value (for example, 50 m) and the maximum sensing angle is set to a wide angle value (for example, ±30°), the intermediate-distance transmission antenna group having the intermediate-distance sensing range in which the maximum sensing distance is set to an intermediate-distance value (for example, 100 m) and the maximum sensing angle is set to an intermediate angle value (for example, ±20°), and the long-distance transmission antenna group having the long-distance sensing range in which the maximum sensing distance is set to a long-distance value (for example, 200 m) and the maximum sensing angle is set to a narrow angle value (for example, ±10°).

In each of the transmission antenna groups, the maximum sensing distance is in proportion to the number of transmission antennas included in the corresponding transmission antenna group, and the maximum sensing angle is in reverse proportion to a value that is obtained by multiplying the number of the transmission antennas included in the corresponding transmission antenna group by the antenna interval.

As described above, according to the present invention, the integrated radar system 100 having the antennal structure that can sense multiple distances using multiple beams is provided.

Also, the antenna structure which can sense multiple distances using multiple beams while realizing a high angular resolution is provided.

Also, the integrated radar system 100 that can sense targets in various sensing ranges is provided, so that it is not required to mount many radar systems for various sensing ranges on the vehicle, and thus cost savings and mount space reduction become possible to improve the vehicle mount/applicability.

Also, the vehicle control system 700 that senses targets in various sensing ranges and performs vehicle control through the sensed targets is provided.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, each of the components may be implemented as an independent hardware.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. An integrated radar system comprising:
a transmission antenna unit including a plurality of transmission antenna groups having different sensing ranges; and
a reception antenna group receiving reception signals through multiple channels.

2. The integrated radar system as claimed in claim 1, wherein each of the plurality of transmission antenna groups has an antenna structure in which one or more transmission antennas are arranged according to one or more of the number of antennas and an antenna interval, which are for differently setting one or more of a maximum sensing distance and a maximum sensing angle so that the transmission antennas have different sensing ranges.

3. The integrated radar system as claimed in claim 2, wherein the maximum sensing distance is in proportion to the number of transmission antennas, and the maximum sensing angle is in reverse proportion to a value that is obtained by multiplying the number of the transmission antennas by an antenna interval.

4. The integrated radar system as claimed in claim 2, wherein the plurality of transmission antenna groups includes two or more of
a short-distance transmission antenna group having a short-distance sensing range in which the maximum sensing distance is set to a short-distance value and the maximum sensing angle is set to a wide angle value;
an intermediate-distance transmission antenna group having an intermediate-distance sensing range in which the maximum sensing distance is set to an intermediate-distance value and the maximum sensing angle is set to an intermediate angle value; and
a long-distance transmission antenna group having a long-distance sensing range in which the maximum sensing distance is set to a long-distance value and the maximum sensing angle is set to a narrow angle value.

5. The integrated radar system as claimed in claim 2, wherein the plurality of transmission antenna groups has an antenna gain that is in proportion to the number of antennas and the maximum sensing distance.

6. The integrated radar system as claimed in claim 1, further comprising a transmission antenna switching unit selecting and switching a specified transmission antenna group having a specified sensing range among the plurality of transmission antenna groups to transmit the transmission signal to the specified sensing range.

7. The integrated radar system as claimed in claim 6, wherein the above-described transmission antenna switching unit performs switching of the specified transmission antenna groups having specified sensing ranges among the plurality of transmission antenna groups one by one in a time division method in order to simultaneously transmit the transmission signals to the plurality of specified sensing ranges.

8. The integrated radar system as claimed in claim 6, further comprising a control unit which controls the transmission antenna switching unit to perform switching of the plurality of transmission antenna groups, and performs vehicle control through target sensing by respective sensing ranges based on the reception signals.

9. The integrated radar system as claimed in claim 1, wherein each of the plurality of transmission antenna groups comprises one or more array antenna type transmission antennas.

10. The integrated radar system as claimed in claim 1, wherein the reception antenna unit comprises a plurality of array antenna type reception antennas.

11. The integrated radar system as claimed in claim 1, further comprising:
a transmission signal generation unit generating transmission signals;
a signal reception unit receiving reception signals in multiple channels through the reception antenna unit; and
an amplification and signal conversion unit amplifying and converting the reception signals into digital signals.

12. A vehicle control system comprising:
a signal transmission unit transmitting a transmission signal through a specified transmission antenna group having a specified sensing range among a plurality of transmission antenna groups having different sensing ranges;
a signal reception unit receiving a reception signal, for which the transmission signal is reflected by a target that is located in the specified sensing range, through a reception antenna;
a target sensing unit sensing the target based on the reception signal; and
a control unit performing vehicle control using the result of the target sensing.

13. The vehicle control system as claimed in claim 12, wherein the plurality of transmission antenna groups includes two or more of
a short-distance transmission antenna group having a short-distance sensing range in which the maximum sensing distance is set to a short-distance value and the maximum sensing angle is set to a wide angle value;
an intermediate-distance transmission antenna group having an intermediate-distance sensing range in which the maximum sensing distance is set to an intermediate-distance value and the maximum sensing angle is set to an intermediate angle value; and
a long-distance transmission antenna group having a long-distance sensing range in which the maximum sensing distance is set to a long-distance value and the maximum sensing angle is set to a narrow angle value.

14. The vehicle control system as claimed in claim 13, wherein the maximum sensing distance is in proportion to the number of transmission antennas included in the corresponding transmission antenna group, and
the maximum sensing angle is in reverse proportion to a value that is obtained by multiplying the number of the transmission antennas included in the corresponding transmission antenna group by an antenna interval.
